(19) United States
(12) Patent Application Publication
(10) Pub. No.: US 2001/0038873 A1
(43) Pub. Date: Nov. 8, 2001

(54) PROCESSES FOR DISINFESTING FRUIT FLY PESTS IN CITRUS FRUIT

(76) Inventors: SUSAN AJESKA, SALINAS, CA (US); LAURENCE DON BELL, CARMEL, CA (US); JAMES R. LUGG, SALINAS, CA (US); ROBERT L. MANGAN, MCALLEN, TX (US); KRISTA C. SHELLIE, HARLINGEN, TX (US)

Correspondence Address: PATRICK F BRIGHT, BRIGHT & LORING, 633 WEST FIFTH STREET, SUITE 3330, LOS ANGLES, CA, 90071

(21) Appl. No.: 09/113,808

(22) Filed: Jul. 9, 1998

(51) Int. Cl. A23L 1/212

(52) U.S. Cl. 426/419; 426/333

(57) ABSTRACT

Methods for disinfesting insect pests such as the Mexican fruit fly in citrus fruit such as grapefruit with minimal adverse effect on fruit quality include placing and maintaining such fruit for a time period of about 15 to about 21 days at a temperature of about 14° to 18° C. and in a gaseous mixture that includes not more than about 0.05% oxygen by volume, a balance nitrogen or up to 20% carbon dioxide in combination with nitrogen.

This invention relates to processes for disinfesting citrus fruit such as grapefruit, oranges and lemons of insect pests such as the Mexican fruit fly. The processes of this invention comprise placing citrus fruit such as oranges, lemons or grapefruit infested with insect pests such as the Mexican fruit fly in a gaseous atmosphere that contains up to 0.05% oxygen by volume. The balance of the atmosphere comprises inert gases such as nitrogen or up to 20% carbon dioxide in combination with nitrogen. The citrus is held in such an atmosphere for a time in the range of about 15 to about 21 days and at a temperature in the range of about 14° C. to about 18° C. These processes are particularly useful in killing, at all life stages, Mexican fruit flies that have infested grapefruits with minimal adverse effect on desirable fruit qualities such as flavor, texture and odor.

The following examples illustrate the advantages of the processes of this invention in the disinfestation of the Mexican fruit fly in grapefruit, particularly Ruby Red and Rio Red grapefruit varieties.

### EXAMPLE 1

Approximately 25 late third instar Mexican fruit fly larvae were placed into 72 paper cups containing fruit fly rearing diet. 24 media cups were placed into each of 3 plastic containers. The containers were placed into a 10° walk-in chamber and lines supplying either 20% carbon dioxide (balance nitrogen), 0.5% oxygen (balance nitrogen), or air were attached to the inflow of each container. A gas flow of approximately 100 ml/min was established through each container. Four media cups (100 larvae) were removed from each of the containers after 7 days of storage. The remaining 20 media cups (500 larvae) were removed from storage after 14 days. The mortality of the third instar larvae after 7 or 14 days of storage was evaluated by transferring the larvae from each media cup into a container containing vermiculite. The vermiculite inside each of the 72 vermiculite containers was sieved daily until all larvae had either died or pupated.

More larvae died after storage in 0.5% oxygen (2% mortality after 7 days and 14% mortality after 14 days) than after storage in air (0% after 7 days, and 3.2% after 14 days. The actual atmosphere maintained inside the containers during storage ranged from 16 to 22% carbon dioxide and 0 to 2% oxygen. These results indicated that a low oxygen atmosphere was more lethal to the Mexican fruit fly than a moderately elevated carbon dioxide atmosphere.

### EXAMPLE 2

Eighteen “Rio Red” grapefruit were artificially infested with 25%, late third instar Mexican fruit fly larvae. The fruit were artificially infested by removing a plug of fruit tissue from one end of the fruit, and inserting 25 larvae into the hole. The fruit plug was then replaced and the cut fruit surface sealed with hot glue. Six infested grapefruit were placed into each of three plastic containers. These containers were placed inside a walk-in chamber at 10° C. and lines supplying either 20% carbon dioxide balance nitrogen), 0.5% oxygen (balance nitrogen), or air were attached to the inflow of each container. Three grapefruit were removed from each container after 14 days. The remaining three grapefruit inside each container were stored for an additional 7 days (total of 21 days). The mortality of the third instar Mexican fruit fly larvae inside each of the artificially infested grapefruit was measured after the grapefruit were removed from storage by retrieving the larvae from each grapefruit and placing them into a container containing vermiculite. The vermiculite inside each of the 18 vermiculite containers was sieved daily until all larvae had either died or pupated.

More larvae died after storage in 0.5% oxygen (58% mortality after 14 days and 99% mortality after 21 days) or 20% carbon dioxide (41% mortality after 14 days and 70% mortality after 21 days) than after storage in air (15% mortality after 14 days and 47% mortality after 21 days). These result provided evidence that a low oxygen atmosphere was more lethal to the Mexican fruit fly than a moderately elevated carbon dioxide atmosphere.

### EXAMPLE 3

On the day of harvest approximately 2500, late third instar Mexican fruit fly larvae were artificially infested into 105 “Ruby Red” grapefruit. The fruit were artifically infested by removing a plug of fruit tissue from one end of the fruit, and inserting 25 larvae into the hole. The fruit plug was then replaced and the cut fruit surface sealed with hot glue. Fifteen infested fruit were place into each of seven 5-gallon buckets, and the buckets were stored overnight in a walk-in chamber at 10° C. The following morning, lines providing air 20%, 40% or 60% carbon dioxide (balance nitrogen); or 0.05%, 0.10%, or 0.15% oxygen (balance nitrogen) were attached to the inlet of each bucket and a gas flow of approximately 100 ml/min was established through each bucket. After the infested fruit were stored for 14 days, larval mortality was evaluated by retrieving the larvae from each grapefruit and placing them into a container containing vermiculite. A common vermiculite container was used for the 15 fruits within each of the 7 buckets. The vermiculite inside each of the 7 containers was sieved daily until all larvae had either died or pupated.

About 350 larvae (15 grapefruit) were exposed to each of the 7 atmospheres. Larval mortality was higher when fruit were stored in a controlled atmosphere (68% mortality) than when fruit were stored in air (17% mortality). Storage in 40% or 60% carbon dioxide resulted in the highest levels of mortality (96% and 93% respectively). Larval mortality was similar (˜60%) after storage in 20% carbon dioxide, 0.15% or 0.05% oxygen, but lower (35%) after storage in 0.10% oxygen. The inconsistent mortality trend was the result of a failure to maintain the 0.10% oxygen atmosphere inside the bucket containing the infested grapefruit. The actual average percent oxygen level inside the 0.15% bucket was 0.03%. This explains why mortality was similar after storage in 0.15 and 0.05% oxygen.

### EXAMPLE 4

The relative mortality of 6 life stages of Mexican fruit fly (eggs, early first, late first, second, early third, and late third instars) were evaluated after each life stage was stored at 10° or 14° C. for 7, 14, or 21 days in 0.05% oxygen or air. Eggs were collected on plastic rings which were covered with paraffin paper. The paraffin was covered with a thin layer of soft, food gelatine in which laboratory reared, gravid female Mexican fruit flies oviposited. The rings were placed on top of screen cages for 6-7 hours. Eggs were washed from the gel with purified water (reverse osmosis treated), sometimes called R.O. water, and collected on a #80 sieve. The eggs were then rinsed into a beaker with R.O. water and stored in a refrigerator overnight. The following day, 200 eggs were dropped onto a 1 inch square piece of heavy, brown paper toweling with an eyedropper, and the toweling was placed into a 1 pint plastic cup containing approximately 1.5 inches of larval rearing diet. The plastic cups were stored in the rearing facility for 1, 3, 5, 7, or 10 days to allow hatching and development into each of the respective life stages.

After reaching the appropriate life stage, 3 cups were placed into 25%, 5-gallon buckets. Approximately 0.5 inches of water was placed on the bottom of each bucket to prevent desiccation during storage. One bucket containing 3 containers was held in the rearing chamber for 13 days as a check. The other 24 buckets were placed into walk-in chamber at 10° or 14° C. (12 buckets each). Lines supplying either air (6 buckets) or 0.05% oxygen (6 buckets) were attached to the inflow of each bucket, and a gas flow of 100 ml/min was established. Two buckets (6 cups) from each atmosphere were removed from each walk-in chamber after 7, 14, or 21 days of storage. Upon removal, the cups were incubated for 20 days in the larval rearing room. The number of pupae formed after 20 days of storage in air at 80° F. was recorded. The experiment was replicated three times.

Results showed that eggs and late third instar larvae were the most tolerant to storage in 0.05% oxygen at 14° C. and that storage for longer than 15 days at 14° C. or warmer would be the minimum requirements for quarantine security.

### EXAMPLE 5

“Rio Red” grapefruit were harvested and placed inside a screened cage containing gravid female Mexican fruit flies for 24 (eggs) or 48 (third instar larvae) hours. Thirty infested fruit were retained as controls and stored under optimum rearing conditions to estimate the rate of infestation. The remaining fruit were placed inside 5-gallon buckets and stored in 0.05% oxygen at 12°, 14°, or 16° C. for 7, 10, 12, 14, 16, 18, or 21 days. After the fruit were stored for the required duration in 0.05% oxygen, they were transferred to air, cut in half and stored on sand for 2 days inside a sealed, screened container under optimum rearing conditions. Two days after the fruit were cut in half, all larvae and pupae are removed from the fruit and the sand, and stored in a plastic container on vermiculite. After 21 days, the number of pupae in each container was recorded. The pupae were held for an additional 7 days to evaluate for emergence.

The mortality of eggs and late third instars increased as the storage temperature increased from 12° to 16° C. No survivors were encountered after storage in 0.05% oxygen at 16° C. for up to 21 days.

### EXAMPLE ≢

“Rio Red” grapefruit were harvested and stored unwaxed at 10° C. for 21 days in air 20%, 40%, or 60% carbon dioxide (balance nitrogen); or 0.05, 0.10, or 0.15% oxygen (balance nitrogen). Twenty fruit each were placed into 7 5-gallon buckets, and the buckets were stored overnight at 10° C. The following morning, lines providing air, 20%, 40% or 60% carbon dioxide (balance nitrogen); or 0.05, 0.10, or 0.15% oxygen (balance nitrogen) were attached to the inlet of each bucket and a flow of approximately 100 ml/min was established through each bucket. After 21 days of storage in 10° C., the grapefruit were transferred to storage at 21° C. and stored in air for an additional 4 days. Grapefruit market quality attributes (flavor, peel color, soluble solids concentration, titratable acidity, and appearance) were evaluated after one and four days of storage in air at 21° C.

Storage at 10° C. for 21 days in 40% or 60% of carbon dioxide had a deleterious effect on grapefruit flavor, external appearance, and percent juice yield. Fruit stored in all three of the low oxygen atmospheres had similar market quality attributes as fruit stored in air. However, the actual level of oxygen fluctuated inside each of the low oxygen treatment buckets. Results from this experiment suggest that grapefruit will tolerate storage in low oxygen for up to 21 days at 10° C.

### EXAMPLE 7

“Rio Red” grapefruit were harvested, washed, waxed, and dried, and then 20 fruit were placed into each of 15 5-gallon buckets. Five of the buckets were stored overnight at 10°, 12°, or 14° C., and five lines providing air, 0.05% oxygen with 20% carbon dioxide, 0.10% oxygen with 20% carbon dioxide, 0.05% oxygen, or 0.10% oxygen were attached to the inlet of each bucket. A gas flow of approximately 300 ml/min was established through each bucket. After 14 or 21 days of storage in 10°, 12°, or 14° C., the grapefruit were transferred to storage at 21° C. and stored in air for an additional 3 days. Grapefruit market quality attributes (fruit weight, decay, flavor, peel color, soluble solids concentration, titratable acidity, and appearance) were evaluated after three days of storage in air at 21° C. The entire test was replicated 3 times.

Storage in 20% carbon dioxide resulted in lower flavor ratings. The higher the storage temperature and longer the storage duration, the more pronounced the off-flavor. Grapefruit stored in 0.05% oxygen at 14° C. for 21 days were not rated inferior to those stored in 0.05% oxygen at 10° C. for 14 days, although fruit stored in 0.05% oxygen were rated inferior in flavor to fruit stored in air.

### EXAMPLE 8

“Rio Red” grapefruit were washed, waxed, and dried, and 15 fruit were placed into each of 6 5-gallon Buckets. Two buckets were stored overnight at 14°, 16°, or 18° C., and lines providing air or 0.05% oxygen were attached to the inlet of each bucket. A flow of approximately 300 ml/min was established through each bucket. After 14 or 21 days of storage in 14° , 16° , or 18° C., the grapefruit were transferred to 21° C. and stored in air for an additional 14 days. Grapefruit market quality attributes (fruit weight, decay, flavor, peel color, soluble solids concentration, titratable acidity, and appearance) were evaluated after 14 days of storage in air at 21° C. The entire experiment was replicated 3 times for early, mid, and late season fruit.

Flavor ratings, external appearance ratings, and incidence of decay suggested that 18° C. for 21 days was the maximum temperature and storage duration in an atmosphere of 0.05% oxygen that could be tolerated by grapefruit. The flavor of grapefruit stored in 0.05% oxygen at 14°, 16°, or 18 °C. was rated inferior to grapefruit stored in air. However this off-flavor became more pronounced as the temperature increased to 18° C. and the storage duration increased to 21 days. The external appearance of the grapefruit was similar or slightly enhanced by storage in 0.05% oxygen at 14 or 16° C., but started to decline after 21 days of storage in 18° C. Incidence of decay in grapefruit stored in 0.05% oxygen for 21 days and then in air at 21° C. for 14 days was slightly lower than grapefruit stored in air.

What is claimed:

1. A process for disinfesting insect pests in citrus fruits with minimal adverse effect on desirable fruit quality comprising storing said citrus fruit infested with insect pests in a gaseous atmosphere that comprises up to 0.05% oxygen by volume with the balance inert gases such as nitrogen or up to 20% carbon dioxide in combination with nitrogen, at a temperature in the range of about 14° C. to about 18° C. for a time in the range of about 15 days to about 21 days.

2. The method of claim 1 wherein the citrus fruit is grapefruit and the insect pest is the Mexican fruit fly.

3. The method of claim 2 wherein the grapefruit is of the Rio Red variety or Ruby Red variety or both.
